(19) United States
(12) Patent Application Publication
(10) Pub. No.: US 2005/0174410 A1
(43) Pub. Date: Aug. 11, 2005

(54) Composition for printing recording materials

(76) Inventors: Ludwig Hasemann, Mullheim (DE); Stefan Schlosser, Reinach (CH); Reinhard Pedrazzi, Allschwil (CH)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/511,352

(22) PCT Filed: Apr. 10, 2003
(86) PCT No.: PCT/IB03/01350

(30) Foreign Application Priority Data
Apr. 12, 2002 (GB) 0208444.0

(51) Int. Cl. B41J 2/01; C09D 11/00; B32B 3/00

(52) U.S. Cl. 347/100; 106/31.48; 106/31.47; 428/195.1

(57) ABSTRACT

Disclosed are compositions for printing recording materials, especially textile fibre materials, paper and papery substrates and plastic films and plastic transparencies by the inkjet printing process which does not show catalytic fading.

The invention relates to a composition for printing recording materials, especially paper or papery substrates, textile fibre materials, plastic films and plastic transparencies by the inkjet printing process and to the use of the compositions for printing the abovementioned recording materials by means of the inkjet printing process and also to the recording materials printed thereby.

Inkjet printing processes are becoming more and more important for industrial applications. This process is used for instance in the textile industry to replace printing screen processes. Appreciable cost and time savings are possible as a result, since it is no longer necessary to fabricate the individual screens.

Inkjet printing processes are known. In what follows, the principle of inkjet printing will only be discussed very briefly. Details of this technology are described for example in the Ink-Jet-Printing section of R. W. Kenyon in “Chemistry and Technology of Printing and Imaging Systems”, Peter Gregory (editor), Blackie Academic & Professional, Chapmann & Hall 1996, pages 113-138, and references cited therein.

In the inkjet printing process, individual droplets of the ink are sprayed from a nozzle onto a substrate in a controlled manner. The continuous inkjet method and the drop-on-demand method are employed predominantly for this purpose. In the case of the continuous inkjet method, the droplets are produced continuously and droplets not needed for printing are diverted into a collecting vessel and recycled. In the case of the discontinuous drop-on-demand method, by contrast, droplets are generated and printed as desired, i.e. droplets are only generated when this is necessary for printing. The droplets may be generated for example by means of a piezo inkjet head or by means of thermal energy (bubble jet).

In hot melt inkjet printer solid hot melt inks are loaded in a printer capable of melting the ink in the inkjet printer head, ejecting the liquid ink which quickly resolidifies upon impacting a substrate. Conventional hot melt inkjet printers operate with a printing head and inkjet temperature of about 120 to about 150° C. At those temperatures, the solid ink is melted to a low viscosity liquid, generally about 8 to 25 cP when measured at jetting temperature.

By additionally disposing at least one nozzle with yellow, magenta or cyan ink side by side it is possible to obtain colour reproductions in high quality. This process is known as polychromatic printing or, when three colour components are used, as trichromatic printing.

The composition of the ink for the inkjet printing process has to possess a suitable conductivity, sterility in storage, viscosity and surface tension to meet the specific requirements of inkjet ink. In addition, the prints on the recording materials have to have good properties and fastness.

The composition of the invention can be used with all known and suitable inkjet printers for printing paper or papery substrates, textile fibre materials, plastic films and plastic transparencies. This applies not only to the use in monochromatic printing but also to polychromatic printing, especially trichromatic printing.

The composition of the ink for the inkjet printing process has to possess a suitable conductivity, sterility in storage, viscosity and surface tension to meet the specific requirements of inkjet ink. In addition, the prints on the recording materials have to have good properties and fastness.

Useful recording materials, as mentioned above, are preferably paper and papery substrates, textile fibre materials, plastic films and plastic transparencies. But glass and metal may be used as well.

Useful papers or papery substrates include all known such materials. Preference is given to papers or papery substrates coated on at least one side with a material which is particularly receptive to ink compositions. Such papers or papery materials are described inter alia in DE 3018342, DE 4446551, EP 164196 and EP 875393. Useful papers also include papers made up mainly of synthetic pulp and wood pulp as well as paper made up of synthetic pulp alone. If desired, synthetic fibers, inorganic fibers, vegetable fibers except for wood pulp, etc. can be added. The paper may comprise thermoplastic polymers, for example, homo- or co-polymers of vinyl monomers such as ethylene, propylene, acrylonitrile, styrene, acrylic ester, vinyl acetate, vinyl chloride and vinylidene chloride, polyamides and polyesters.

Useful textile fibre materials are in particular hydroxyl-containing fibre materials. Preference is given to cellulosic fibre materials, which consist of or comprise cellulose. Examples are natural fibre materials such as cotton, linen or hemp and regenerated fibre materials such as, for example, viscose and also lyocell.

Particular preference is given to viscose or preferably cotton. The fibre materials mentioned are preferably present as sheetlike textile wovens, formed-loop knits or webs.

In a preferred embodiment of the present invention, the printing is preceded by a pretreatment of the fibre material whereby the fibre material to be printed is first treated with an aqueous alkaline liquor and the treated fibre material is dried, if desired.

Useful plastic films or plastic transparencies include all known such materials. Preference is given to plastic films or plastic transparencies coated on at least one side with a material which is particularly receptive to the ink compositions. Such plastic films or plastic transparencies are described inter alia in EP 755332, U.S. Pat. No. 4,935,307, U.S. Pat. No. 4,956,230, U.S. Pat. No. 5,134,198 and U.S. Pat. No. 5,219,928.

In case of high definition ink jet printing when a plurality of dots are contiguous or overlap, there was a drawback that high definition image could not be obtained due to spreading of dots. In particular, image degradation due to blurring and catalytic fading may be conspicuous in the color mixed portions or at the connecting portions of serial scan.

Catalytic fading describes a process wherein the mixture of dyestuffs fades under the influence of light or other influences like for example heat or moisture, quicker than the single dyestuff under the same conditions. Usually organometallic compounds, especially transition organometallic compounds are known to promote or catalize the fading of other dyes when applied in mixtures while these transition organometallic compounds used alone usually have superior fastnesses to light when applied alone and not in mixtures with other dyes.

Ink jet printing processes including a first step of attaching the ink onto a printing substrate using a print head having discharge ports for use with the discharge of ink are usually followed by a second step of fixing a dye contained in said ink onto said printing substrate.

In said first step, the ink is discharged so that an ink dot formed with one time of discharging operation through said one discharge port may have an area coverage ratio of less than 100% relative to the area of a corresponding print picture element. However it is still possible that two neighbouring dots are overlapping due to blurring or due to the size of the dot which may be slightly bigger relative to the area of a corresponding print picture element. And, in addition, is is generally possible to print one dot onto the other dot which means to let overlap the printing dots on purpose.

The problem of reproducing color with inks containing real dyes is that the yellow, magenta and cyan inks have secondary absorptions in unwanted regions of the visible spectrum. If ideal inks could be used, the amount of ink required to reproduce a color could be calculated in a straightforward way based on the principal absorption bands of the primary inks.

For example, if the green scanner measures some amount of green absorbed in the original, then by knowing the green absorbance of magenta ink, the amount of magenta ink required to obtain a similar green absorption can be determined. However, cyan and yellow inks also have some secondary absorption bands in the green region, and if some of these inks must be printed with magenta, an excess amount of absorbed green occurs in the reproduction. Other secondary added compound may enlarge the color-matching error.

In addition to providing a wide color range, the inks must be colorfast and pH stable, and they should not aggregate at the concentrations used. A serious problem is catalytic fading occuring in the areas where two or more ink dots comprising different dyestuffs are in contact, e.g. by overlapping, which makes the reproducing of colors with inks containing real dyes extremly difficult due to this additional and not predicable color shift caused by the catalytic fading which makes an unpredictable contribution to the color-matching error.

Therefore the additional catalytic fading makes it even less predictable.

As a result of examinations using the above-cited ink jet recording apparatus for the textile printing to make color printing by discharging a plurality of color inks directly onto the cloths, the present inventors have found that it is requisite to prevent the catalytic fading of dots or parts of the dots which are overlapping to obtain a high quality color image. That is, when a plurality of dots are contiguous or overlap, there was a drawback that high definition image could not be obtained due to catalytic fading of the dyestuffs comprised in the printed dots. In particular, image degradation due to catalytic fading may be conspicuous in the color mixed (overlapping) portions or at the connecting portions of serial scan.

An additional object of the present invention is therefore to prevent blurring of the prints made on the substrate.

The above mentioned problem with blurring and catalytic fading is not only a problem in high definition ink jet recording but also in normal ink jet printing process, since the dots are in those processes usually larger and the possible area of overlap is significantly higher than in the so called hight definition ink jet recording process.

It's therefore a object of the present application to find dyestuffs and inks prepared from this dyestuffs which when printed onto the same area on a substrate do not show catalytic fading and do not blur.

It has been found that dyestuffs according to the formula (I) or (II) or (IIIa) or (IIIb) or (IV) or (V) or (VI) or (VII) or (VIII) or (IX) or (X) or (XI) do not fade differently if at least two of these dyestuffs selected from the group (I) or (II) or (IIIa) or (II lb) or (IV) or (V) or (VI) or (VII) or (VIII) or (IX) or (X) or (XI) are brought in contact on a substrate and having a common overlapping area on said substrate than the same single dyestuffs selected from (I) or (II) or (IIIa) or (IIIb) or (IV) or (V) or (VI) or (VII) or (VIII) or (IX) or (X) or (XI) are brought alone (e.g. without having a common overlapping area) onto a substrate when the dystuffs have the following formula 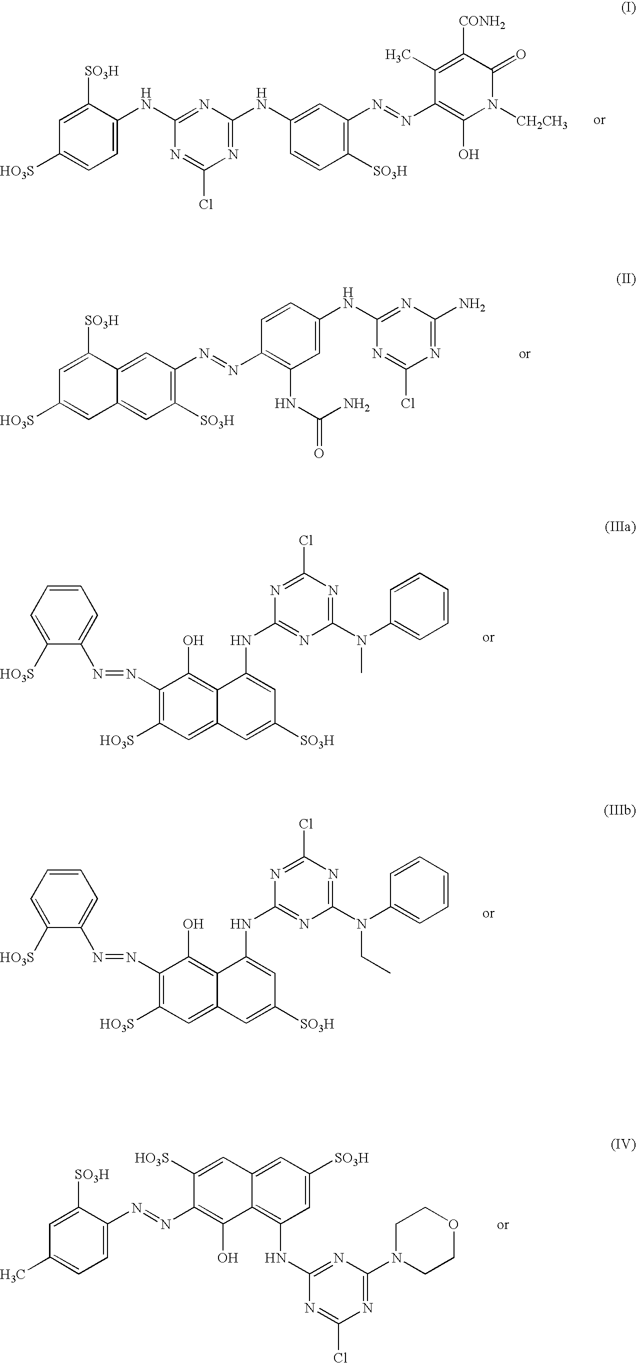 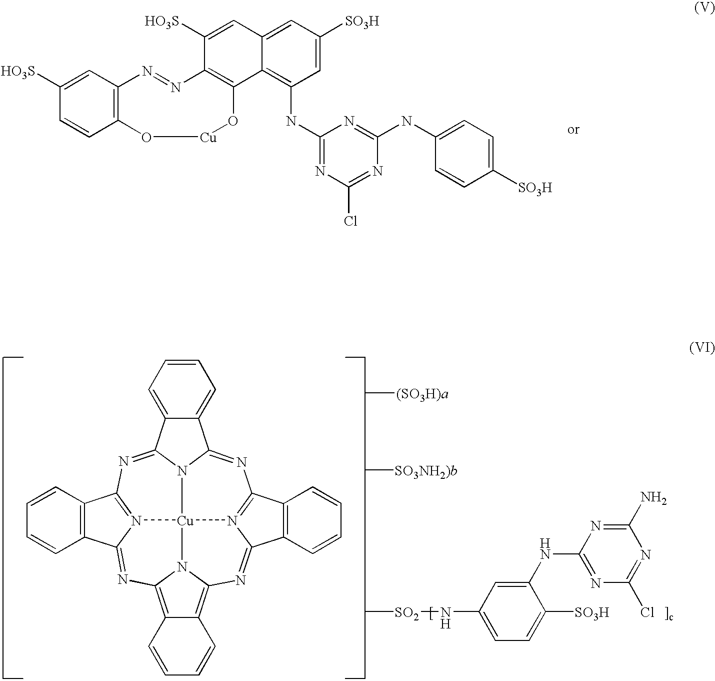
with a having values from 4 to 0 and b having values from 0 to 4 with the proviso that the sum of a+b does not exceed 4 and c has the values from 1 to 2.
or 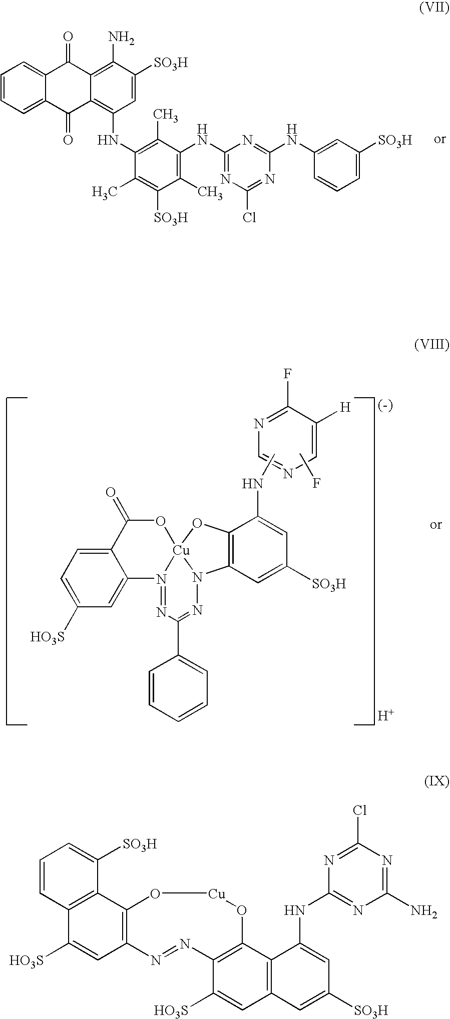
or dye composition (X) which is a mixture comprising the following three dyestuffs (Xa), (Xb) and (Xc)
61 parts of the dye (Xa) 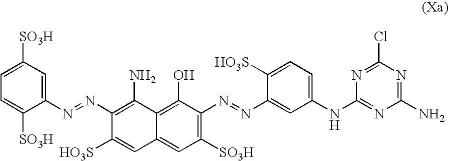
   28 parts of the dyes (Xb) 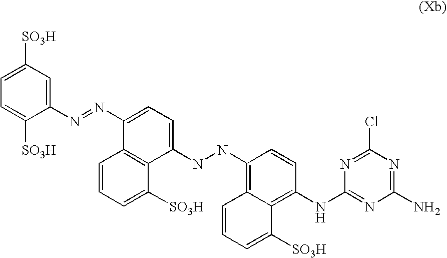
and
9 parts of the dye (Xc)

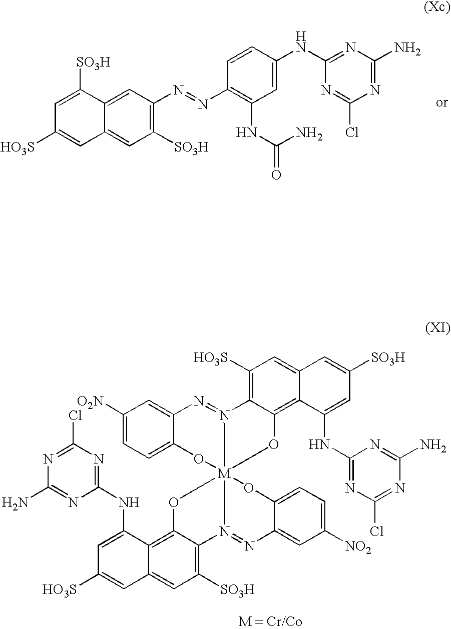

This invention further provides a composition for printing recording materials comprising
1) at least one dye of the formula (I) or (II) or (IIIa) or (IIIb) or (IV) or (V) or (VI) or (VII) or (VIII) or (IX) or (X) or (XI),
2) water or a medium including a mixture of water and an organic solvent, an anhydrous organic solvent or a solid having a low melting point,
   and
3) optionally further additives.

This invention further provides a composition for printing recording materials, comprising
1) at least one dye of the formula (I) or (V) or (VI) or (VIII),
2) water or a medium including a mixture of water and an organic solvent, an anhydrous organic solvent or a solid having a low melting point, and
3) optionally further additives.

A further object of the invention is a process for printing showing no catalytic fading comprising in a first step applying at least one dyestuff or a dyestuff mixture selected from the dyes of the formula (I) or (II) or (IIa) or (IIIb) or (IV) or (V) or (VI) or (VII) or (VIII) or (IX) or (X) or (XI) and in a second step applying at least one dyestuff or a dyestuff mixture selected from at dye of the formula (I) or (II) or (IIIa) or (IIIb) or (IV) or (V) or (VI) or (VII) or (VIII) or (IX) or (X) or (XI) with the proviso that the dyestuff or mixture of dyestuffs in the second step is not the same dyestuff or mixture of dyestuff as selected in the first step. By preference this printing method is an ink jet printing method and is applied to substrates of cellulosic materials.

After this second step a third step a comprising applying at least one dyestuff or an dyestuff mixture selected from at dye of the formula (I) or (II) or (IIa) or (IIIb) or (IV) or (V) or (VI) or (VII) or (VIII) or (IX) or (X) or (XI) with the proviso that the dyestuff or mixture of dyestuffs in the third step is not the same dyestuff or mixture of dyestuff selected in the first or second step.

A further object of the invention is a process for ink jet printing of cellulosic materials comprising in a first step applying at least one dyestuff or a dyestuff mixture selected from the dyes of the formula (I) or (II) and in a second step applying at least one dyestuff or a dyestuff mixture selected from at dye of the formula (IIIa) or (IIIb) or (IV) and in a third step applying at least one dyestuff or a dyestuff mixture selected from at dye of the formula (V) or (VI) or (VII) or (VIII) or (IX). In a fourth step it is possible to apply at least one dyestuff or a dyestuff mixture selected from at dye of the formula (X) or (XI).

A further object of the invention is a process for ink jet printing of cellulosic materials comprising in a first step applying at least one dyestuff or a dyestuff mixture selected from the dyes of the formula (V) or (VI) or (VIII) or (XI) and in a second step applying at least one dyestuff or a dyestuff mixture selected from at dye of the formula (I) or (II) or (IIIa) or (IIIb) or (IV) or (V) or (VI) or (VII) or (VIII) or (IX) or (X) or (XI) with the proviso that the dyestuff or mixture of dyestuffs in the second step is not the same dyestuff or mixture of dyestuff as selected in the first step.

The dyes are by preference dissolved in water or a medium including a mixture of water and an organic solvent, an anhydrous organic solvent or a solid having a low melting point during the ink jet printing process.

However, in the above mentioned objects of the invention the steps may also be executed in the reverse order or in any order which means the order of the steps is not critical to this invention.

Preferably paper and papery substrates, textile fibre materials, plastic films and plastic transparencies comprising hydroxy groups are printed. Preferably the printing process is an ink jet printing process.

A further aspect of the invention comprises the use of a dyestuff according to formula (I) in an ink jet printing process. A further aspect of the invention comprises the use of a dyestuff according to formula (II) in an ink jet printing process. A further aspect of the invention comprises the use of a dyestuff according to formula (IIIa) in an ink jet printing process. A further aspect of the invention comprises the use of a dyestuff according to formula (IIb) in an ink jet printing process. A further aspect of the invention comprises the use of a dyestuff according to formula (IV) in an ink jet printing process. A further aspect of the invention comprises the use of a dyestuff according to formula (V) in an ink jet printing process. A further aspect of the invention comprises the use of a dyestuff according to formula (VI) in an ink jet printing process.

A further aspect of the invention comprises the use of a dyestuff according to formula (VII) in an ink jet printing process. A further aspect of the invention comprises the use of a dyestuff according to formula (VIII) in an ink jet printing process. A further aspect of the invention comprises the use of a dyestuff according to formula (IX) in an ink jet printing process. A further aspect of the invention comprises the use of a dyestuff according to formula (X) in an ink jet printing process wherein the dyestuff (X) is a composition comprising at least the dyestuffs (Xa), (Xb) and (Xc). A further aspect of the invention comprises the use of a dyestuff according to formula (XI) in an ink jet printing process.

A particular aspect of the present invention comprises the use of a dyestuff according to formula (I) or (V) or (VI) or (VIII) in an ink jet printing process.

The dyes used for the inventive composition of the printing ink are known from the PCT Patent Application WO97/30125, GB2066283, WO00/06653, GB2224511, GB866513 and EP522339. The preparation of these compounds is likewise carried out according to the synthesis specified in WO97/30125, GB2066283, GB222451, GB866513 and EP522339.

By preference the sum of a+b in the compound of formula (VI) is not more than four.

The values of a and b do not reflect necessarily an exact amount of SO₃H-groups or SO₃NH₂-groups, but rather a statistical number, e.g. maximum of the statistical distribution. For example when a is 2 and b is 1 the number of SO₃H-groups may fall in the range 0 and 4 and the number of SO₃NH₂-groups may fall in the range of between 0 and 4 with the proviso that the sum of a and b does not exceed 4. Other examples for the values of a and b in the formula (VI) are: a=1,7 and b=1; a=1 and b=2. c may have the value between 1 and 2. Also the value of c is a statistical number and may be 1 or 2 or any value between 1 and 2.

The dyes of the formula (I) used in the inks should preferably be low in salt, i.e. have a total salt content of less than 0.5% by weight, based on the weight of the dyes. Dyes having higher salt contents (owing to their preparation and/or the subsequent addition of extenders) may be desalted, for example by means of membrane separation processes, such as ultrafiltration, reverse osmosis or dialysis.

The dyes in the inks are exclusively sulpho-containing, water-soluble reactive dyes.

The inks preferably include a total amount of dyes of the above formula (I) or (II) or (IIIa) or (IIIb) or (IV) or (V) or (VI) or (VII) or (VIII) or (IX) or (X) or (XI) which is in the range from 1 to 35% by weight, especially in the range from 2 to 35% by weight, preferably in the range from 2 to 30% by weight, more preferably in the range from 2 to 20% by weight, based on the total weight of the ink.

The inks include 99-65% by weight, especially 98-65% by weight, preferably 98-70% by weight, more preferably 98-80% by weight, of an abovementioned medium 2), which includes a mixture of water and an organic solvent, an anhydrous organic solvent or a solid having a low melting point.

When said medium 2) is a mixture including water and an organic solvent or an anhydrous organic solvent, then the dye of the formula (I) or (II) or (IIIa) or (IIIb) or (IV) or (V) or (VI) or (VII) or (VIII) or (IX) or (X) or (XI) or mixtures thereof are preferably completely dissolved in this medium.

Preferably the dye of the formula (I) or (II) or (IIIa) or (IIIb) or (IV) or (V) or (VI) or (VII) or (VIII) or (IX) or (X) or (XI) or mixtures thereof have a solubility of not less than 2% by weight in this medium 2) at 20° C.

When the ink composition of the invention is used for printing paper or papery substrates, the inks are preferably used together with the following compositions.

When the medium is a mixture of water and an organic solvent, the weight ratio of water to organic solvent is preferably in the range from 99:1 to 1:99, more preferably in the range from 99:1 to 50:50, particularly preferably in the range from 95:5 to 80:20.

It is preferable for the organic solvent which is included in the mixture with water to be a water-soluble solvent or a mixture of various water-soluble solvents. Preferred water-soluble organic solvents are C₁₋₆-alcohols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and keto alcohols, preferably acetone, methyl ethyl ketone, cyclohexanone and diacetone alcohol; water-miscible ethers, preferably tetrahydrofuran and dioxane; diols, preferably diols possessing 2 to 12 carbon atoms, e.g. 1,5-pentanediol, ethylene glycol, propylene glycol, butylene glycol, pentylene glycol, hexylene glycol and thiodiglycol and oligo- and poly-alkylene glycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols possessing 2 to 12 carbon atoms, particularly preferably 2-methoxyethanol, 2-(2-methoxyethoxy)ethanol, 2-(2-ethoxyethoxy)ethanol, 2-[2-(2-methoxyethoxy)ethoxy]ethanol, 2-[2-(2-ethoxyethoxy)ethoxy]ethanol and ethylene glycol monoallyl ether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulphoxides, preferably dimethyl sulphoxide and sulpholane.

In a preferred composition, the medium as per 2) includes water and at least 2 or more, more preferably 2 to 8, water-soluble organic solvents.

Particularly preferred water-soluble solvents are cyclic amides, particularly 2-pyrrolidone, N-methylpyrrolidone and N-ethylpyrrolidone; diols, preferably 1,5-pentanediol, ethylene glycol, thiodiglycol, diethylene glycol and triethylene glycol; and mono-C₁₋₄-alkyl and C₁₋₄-alkyl ethers of diols, more preferably mono-C₁₋₄-alkyl ethers of diols possessing 2 to 12 carbon atoms, particularly preferably 2-methoxy-2-ethoxy-2-ethoxyethanol.

A preferred medium as per 2) includes:
(a) 75 to 95 parts by weight of water and
(b) 25 to 5 parts of one or more of the following solvents: diethylene glycol, 2-pyrrolidone, thiodiglycol, N-methylpyrrolidone, cyclohexanol, caprolactone, caprolactam and 1,5-pentanediol,
   wherein the parts are by weight and all parts of (a) and (b) add up to 100.

Examples of further useful ink compositions including water and one or more organic solvents are found in the Patent Specifications U.S. Pat. No. 4,963,189, U.S. Pat. No. 4,703,113, U.S. Pat. No. 4,626,284 and EP 425150A.

When the medium as per 2) includes an anhydrous (i.e. less than 1% by weight of water) organic solvent, this solvent will have a boiling point of 30 to 200° C., more preferably of 40-150° C., particularly preferably of 50-125° C.

The organic solvent can be water-insoluble, water-soluble or mixtures of such solvents.

Preferred water-soluble organic solvents are all above-described water-soluble organic solvents and mixtures thereof.

Preferred water-insoluble solvents include inter alia aliphatic hydrocarbons; esters, preferably ethyl acetate; chlorinated hydrocarbons, preferably CH₂Cl₂; and ethers, preferably diethyl ether; and mixtures thereof.

When the liquid medium as per 2) includes a water-insoluble organic solvent, it is preferable to add a polar solvent to increase the solubility of the dye in the liquid medium.

Examples of such polar solvents are C₁₋₄-alcohols, preferably ethanol or propanol; ketones, preferably methyl ethyl ketone.

The anhydrous organic solvent can consist of a single solvent or a mixture of 2 or more different solvents.

When it is a mixture of different solvents, a mixture including 2 to 5 different anhydrous solvents is preferred. This makes it possible to provide a medium as per 2) which permits good control of the drying properties and of the stability of the ink composition in storage.

Ink compositions including an anhydrous organic solvent or mixtures thereof are of particular interest when rapid drying times are required and especially when they are used for prints on hydrophobic and non-absorbing substrates, such as plastic, metal and glass.

Preferred low-melting media have a melting point of 60 to 125° C. Useful low-melting solids include long-chain fatty acids or alcohols, preferably those having a C₁₈₋₂₄-carbon chain, and sulphonamides. Conventional low-melting ink vehicles generally include various proportions of waxes, resins, plasticizers, tackifiers, viscosity modifiers and antioxidants.

The ink composition and the printing pastes of the invention may further include as auxiliaries additional components which are normally used in inkjet inks or printing pastes, for example buffers, viscosity improvers, surface tension improvers, fixation accelerants, biozides, corrosion inhibitors, levelling agents, drying agents, humefactants, ink penetration additives, light stabilisers, UV absorbers, optical brighteners, coagulation reducers, ionic or nonionic surfactants and conducting salts.

These auxiliaries are preferably added in an amount of 0-5% by weight.

To prevent precipitations in the ink compositions of the invention, the dyes used have to be purified clean. This can be done with commonly known purifying methods.

When the compositions of the invention are used for printing textile fibre materials, preference is given to using the following compositions.

When printing textile fibre materials, useful additives, as well as the solvents, include water-soluble nonionic cellulose ethers or alginates.

Useful water-soluble nonionic cellulose ethers include for example methyl-, ethyl-, hydroxyethyl-, methylhydroxyethyl-, hydroxypropyl- or hydroxypropylmethyl-cellulose. Preference is given to methylcellulose or in particular hydroxyethylcellulose. Cellulose ethers are customarily used in the ink in an amount of 0.01 to 2% by weight, especially 0.01 to 1% by weight, preferably 0.01 to 0.5% by weight, based on the total weight of the ink.

Useful alginates include in particular alkali metal alginates, preferably sodium alginate. These are customarily used in the ink in an amount of 0.01 to 2% by weight, especially 0.01 to 1% by weight, preferably 0.01 to 0.5% by weight, based on the total weight of the ink.

Both the water-soluble nonionic cellulose ethers used and the alginates are used as thickeners to adjust the ink to a certain viscosity.

Preference is given to ink compositions having a viscosity of 1 to 40 mPa·s, especially 5 to 40 mPa·s, preferably 10 to 40 mPa·s. Ink compositions having a viscosity of 10 to 35 mPa·s are particularly preferred.

Preference is given to ink compositions having a surface tension of 15-73 mN/m, especially 20-65 mN/m, particularly preferably 30-50 mN/m.

Preference is given to ink compositions having a conductivity of 0.1-100 mS/cm, especially 0.5-70 mS/cm, particularly preferably 1.0-60 mS/cm.

The inks may further include buffer substances, for example borax, borate or citrate. Examples are sodium borate, sodium tetraborate and sodium citrate.

They are used in particular in amounts of 0.1 to 3% by weight, preferably 0.1 to 1% by weight, based on the total weight of the ink, to set a pH of for example 5 to 9, especially 6 to 8. A citrate buffer is preferred in the case of alginatic inks.

As further additives the inks may include for example N-methyl-2-pyrrolidone or especially 1,2-propylene glycol. These are customarily used in the ink in an amount of 5 to 30% by weight, especially 5 to 20% by weight, preferably 10 to 20% by weight, based on the total weight of the ink.

The inks may further include customary additives, for example foam suppressants or especially fungal and/or bacterial growth inhibitors. These are customarily used in amounts of 0.01 to 1% by weight, based on the total weight of the ink.

The aqueous ink includes at least one of the customary bases which are used in conventional reactive printing processes to fix the reactive dyes. The base is used for example in an amount of 10 to 100 g/l of liquor, preferably 10 to 50 g/l of liquor. Useful bases include for example sodium carbonate, sodium hydroxide, disodium phosphate, trisodium phosphate, sodium acetate, sodium propionate, sodium bicarbonate, aqueous ammonia or alkali donors, for example sodium chloroacetate or sodium formate. Preference is given to using sodium bicarbonate, sodium carbonate or a mixture of sodium silicate and sodium carbonate. The pH of the liquor is generally 6.0 to 13.5, preferably 6.5 to 11.5 and most preferably between 7.0 and 9.0. As well as the bases, the aqueous alkaline liquor may include further additives, for example hydrotropicizers. The preferred hydrotropicizer is urea, which is used for example in an amount of 25 to 200 g/l of liquor, preferably 50 to 150 g/l of liquor. Preferably the fibre material is dried after the above pretreatment.

After printing, the fibre material is advantageously dried, preferably at temperatures up to 150° C., especially 80 to 120° C., and subsequently subjected to a heat treatment process to complete the print or fix the dye.

The heat treatment can be carried out for example by means of a hot batch process, a thermosoling process or preferably a steaming process. In the steaming process, the printed fibre material is subjected for example to a treatment in a steamer with superheated or nonsuperheated steam, advantageously at a temperature of 95 to 180° C., advantageously in saturated steam. Thereafter the printed fibre material is generally washed off with water in a conventional manner to remove unfixed dye.

The present invention further provides aqueous printing inks for the inkjet printing process, which are characterized in that they include
a) 5 to 35% by weight of at least one dye of the above formula (I) or (II) or (IIIa) or (IIIb) or (IV) or (V) or (VI) or (VII) or (VIII) or (IX) or (X) or (XI) and
b) 0.01 to 2% by weight of a water-soluble nonionic cellulose ether or of an alginate.

The printing inks and also the dyes of the formulae (I) are subject to the above-indicated meanings and preferences.

The prints obtainable by the process of the invention have good general fastnesses, for example a high fibre-dye bond stability not only in the acid but also in the alkaline region, a good lightfastness, good wetfastnesses, such as fastness to washing, water, sea water, crossdying and perspiration, a good chlorine fastness, rub fastness, fastness to hot pressing and pleating and also sharp contours and a high colour strength. The printing inks used are notable for good stability and good viscosity properties. The viscosity remains virtually unchanged even in the event of high shearing forces occurring during printing.

A further aspect of the present invention is the use of the printing ink in trichromatic printing. Trichromatic printing is a very large application for all recording materials.

This form of printing is normally carried out with a yellow, red and blue ink composition.

This invention further provides recording materials which have been printed with a composition according to the invention.

The examples hereinbelow illustrate the invention. Temperatures are in degrees Celsius; parts and percentages are by weight, unless otherwise stated.

Examples of ink compositions:

The fractions of the individual components of the ink compositions are given.
1-35 parts of a dye of the formula (I) or (II) or (IIIa) or (IIIb) or (IV) or (V) or (VI) or (VII) or (VIII) or (IX) or (X) or (XI) and/or its salt or mixtures of various dyes of the formula (I) or (II) or (IIIa) or (IIIb) or (IV) or (V) or (VI) or (VII) or (VIII) or (IX) or (X) or (XI),
65-99 parts of water or a medium including a mixture of water and an organic solvent, an anhydrous organic solvent or a solid having a low melting point and optionally
0-5 parts of one or more additives.

The total sum of all the parts of a composition according to the invention is 100 parts.
2-9 parts of a dye of the formula (I) or (II) or (IIIa) or (IIIb) or (IV) or (V) or (VI) or (VII) or (VIII) or (IX) or (X) or (XI) and/or its salt or mixtures of various dyes of the formula (I) or (II) or (IIIa) or (IIIb) or (IV) or (V) or (VI) or (VII) or (VIII) or (IX) or (X) or (XI),
15-30 parts of glycerol and
61-83 parts of water.
   the total sum of all the parts not being more than being 100.
1-4 parts of a dye of the formula (I) or (II) or (IIIa) or (IIIb) or (IV) or (V) or (VI) or (VII) or (VIII) or (IX) or (X) or (XI) and/or its salt or mixtures of various dyes of the formula (I) or (II) or (IIIa) or (IIIb) or (IV) or (V) or (VI) or (VII) or (VIII) or (IX) or (X) or (XI) and
96-99 parts of a medium comprising of 80-95 parts of water and 20-5 parts of 2-pyrrolidone wherin the sum of the parts water and the parts of 2-pyrrolidone in this medium are 100 and
   the total sum of all the parts not being more than being 100.

A preferred ink composition of the invention consists of
6 parts of a dye of the formula (I) or (II) or (IIIa) or (IIIb) or (IV) or (V) or (VI) or (VII) or (VIII) or (IX) or (X) or (XI) and/or its salt or mixtures of various dyes of the formula (I) or (II) or (IIIa) or (IIIb) or (IV) or (V) or (VI) or (VII) or (VIII) or (IX) or (X) or (XI),
20 parts of glycerol and
74 parts of water.

The abovementioned composition is preferably prepared by heating the medium to 40° C. and then adding a dye of the formula (I) or a mixture thereof. The composition is then cooled down to room temperature.

This ink composition is preferably used for printing cellulosic textiles, papers or papery substrates.

A further preferred ink composition according to the invention consists of
2 parts of a dye of the formula (I) or (II) or (IIIa) or (IIIb) or (IV) or (V) or (VI) or (VII) or (VIII) or (IX) or (X) or (XI) and/or its salt or mixtures of various dyes of the formula (I) or (II) or (IIIa) or (IIIb) or (IV) or (V) or (VI) or (VII) or (VIII) or (IX) or (X) or (XI) and
98 parts of a medium consisting of 90 parts of water and 10 parts of 2-pyrrolidone.

A further preferred ink composition according to the invention consists of
2-9 parts of a dye of the formula (I) or (II) or (IIIa) or (IIIb) or (IV) or (V) or (VI) or (VII) or (VIII) or (IX) or (X) or (XI) and/or its salt or mixtures of various dyes of the formula (I) or (II) or (IIIa) or (IIIb) or (IV) or (V) or (VI) or (VII) or (VIII) or (IX) or (X) or (XI),
0.2-1 parts of hydroxyethylcellulose,
0.3-1 parts of borax
89-97.5 parts of water.
   the total sum of all the parts not being more than being 100.

### APPLICATION EXAMPLES

The following application examples are all printed in the standard depth of colour=1/1.

This makes the various testprints comparable. Where overlaping areas were printed (application examples 13 to 31), less dye was used of each component in order to achieve again a standard depth of colour being the same as in the application examples 1 to 12.

The dyed swatches were exposed to light by the ISO 105B04 standard test during 100 hours. Afterwards the fabrics are assessed by the Grey Scale Change ISO A03.

### Application Example 1

An ink consisting of 4.6 parts of the dye of formula (I) 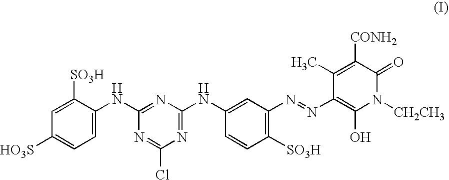
in 97.5 parts of a mixture of water and 2-pyrrolidone where the ratio of water to 2-pyrrolidone is 90:10 is introduced into an HP 880C Deskjet Printer and printed onto an A4 HP Premium Inkjet paper (HP and Deskjet are registered trademarks of Hewlett-Packard, Palo Alto, Calif., USA). The brillant yellow prints thus obtained have good fastnesses and especialy good lightfastness properties.

### Application Example 2

a) Mercerized cotton satin is padded with a liquor containing 30 g/l of sodium carbonate to a wet pick-up of 70% and dried.)
a) The cotton satin pretreated as per step a) is printed with an aqueous ink containing 2% by weight of the dye of formula (II) 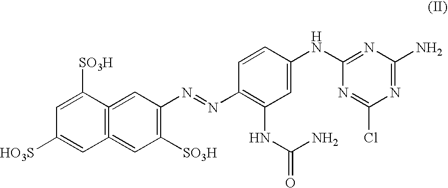
0.3% of hydroxyethylcellulose,
0.5% by weight of borax and
87.2% by weight of water
   using a continuous flow inkjet head. The print is completely dried and fixed in saturated steam at 102° C. for 4 minutes, rinsed cold, washed off at the boil, rinsed once more and dried. A yellow print having good fastnesses and good lightfastness is obtained.

### Application Example 3

a) Mercerized cotton satin is padded with a liquor containing 30 g/l of sodium carbonate to a wet pick-up of 70% and dried.
b) The cotton satin pretreated as per step a) is printed with an aqueous ink containing 3,8% by weight of the dye of formula (IIIa) 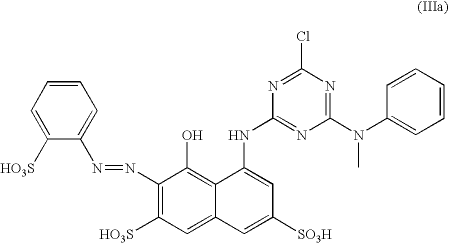
0.3% of hydroxyethylcellulose,
0.5% by weight of borax and
84.2% by weight of water
   using a continuous flow inkjet head. The print is completely dried and fixed in saturated steam at 102° C. for 4 minutes, rinsed cold, washed off at the boil, rinsed once more and dried. A red print having good fastnesses and good lightfastness is obtained.

### Application Example 4

a) Mercerized cotton satin is padded with a liquor containing 30 g/l of sodium carbonate to a wet pick-up of 70% and dried.
b) The cotton satin pretreated as per step a) is printed with an aqueous ink containing 3,8% by weight of the dye of formula (IIIb) 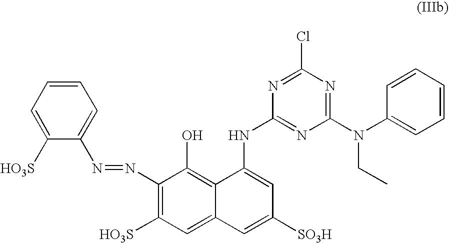
   0.3% of hydroxyethylcellulose,
   0.5% by weight of borax and
   84.2% by weight of water
      using a continuous flow inkjet head. The print is completely dried and fixed in saturated steam at 102° C. for 4 minutes, rinsed cold, washed off at the boil, rinsed once more and dried. A red print having good fastnesses and good lightfastness is obtained.

### Application Example 5

a) Causticized woven viscose is padded with a liquor containing 30 g/l of sodium carbonate to a wet pick-up of 70% and dried.
b) The woven viscose pretreated as per step a) is printed with an aqueous ink containing
   3.4% by weight of the dye of formula (IV) 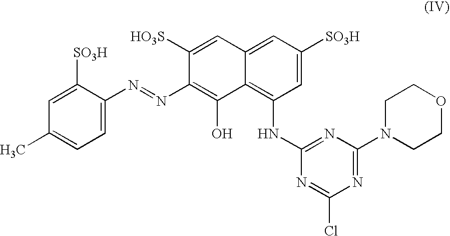
   15% by weight of 1,2-propylene glycol and
   81.6% by weight of water.

The print is completely dried and fixed in saturated steam at 102° C. for 4 minutes, rinsed cold, washed off at the boil, rinsed once more and dried.

A red print having good fastnesses and good lightfastness is obtained.

### Application Example 6

a) Causticized woven viscose is padded with a liquor containing 30 g/l of sodium carbonate to a wet pick-up of 70% and dried.
b) The woven viscose pretreated as per step a) is printed with an aqueous ink containing
   4,4% by weight of the dye of formula (V) 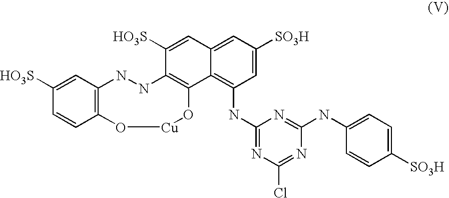
   15% by weight of 1,2-propylene glycol and
   81.6% by weight of water. The print is completely dried and fixed in saturated steam at 102° C. for 4 minutes, rinsed cold, washed off at the boil, rinsed once more and dried.

A violett print having good fastnesses and good lightfastness is obtained.

### Application Example 7

a) Causticized woven viscose is padded with a liquor containing 30 g/l of sodium carbonate to a wet pick-up of 70% and dried.
b) The woven viscose pretreated as per step a) is printed with an aqueous ink containing
   2.8% by weight of the dye of formula (VI) 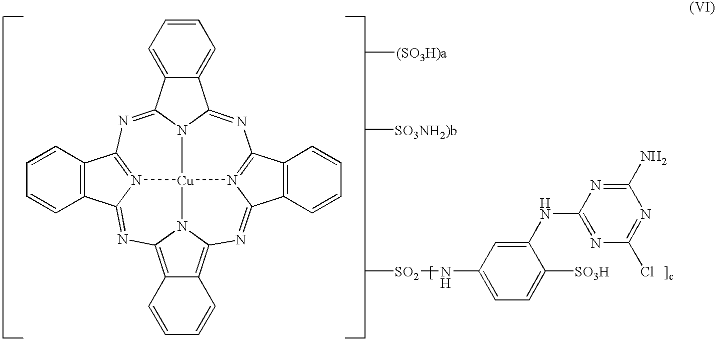
   15% by weight of 1,2-propylene glycol and
   82.2% by weight of water
      using a continuous flow inkjet head. The print is completely dried and fixed in saturated steam at 102° C. for 4 minutes, rinsed cold, washed off at the boil, rinsed once more and dried. A cyan print having good fastnesses and especially good light fastness is obtained.

### Application Example 8

a) Causticized woven viscose is padded with a liquor containing 30 g/l of sodium carbonate to a wet pick-up of 70% and dried.)
b) The woven viscose pretreated as per step a) is printed with an aqueous ink containing
   2.6% by weight of the dye of formula (VII) 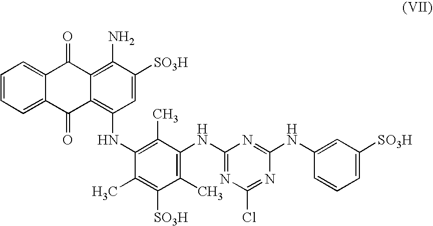
   15% by weight of 1,2-propylene glycol and
   82.4% by weight of water
      using a continuous flow inkjet head. The print is completely dried and fixed in saturated steam at 102° C. for 4 minutes, rinsed cold, washed off at the boil, rinsed once more and dried. A blue print having good fastnesses and especially good light fastness is obtained.

### Application Example 9

a) Causticized woven viscose is padded with a liquor containing 30 g/l of sodium carbonate to a wet pick-up of 70% and dried.
b) The woven viscose pretreated as per step a) is printed with an aqueous ink containing
   3.0% by weight of the dye of formula (VIII) 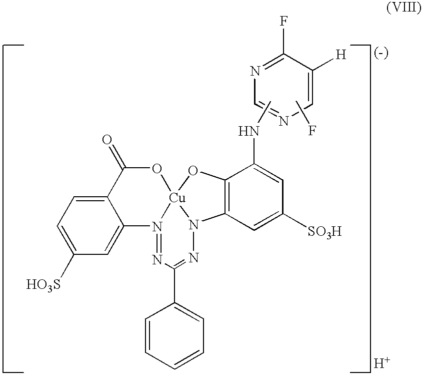
   15% by weight of 1,2-propylene glycol and
   82% by weight of water
      using a continuous flow inkjet head. The print is completely dried and fixed in saturated steam at 102° C. for 4 minutes, rinsed cold, washed off at the boil, rinsed once more and dried. A blue print having good fastnesses and especially good light fastness is obtained.

### Application Example 10

a) Causticized woven viscose is padded with a liquor containing 30 g/l of sodium carbonate to a wet pick-up of 70% and dried.
b) The woven viscose pretreated as per step a) is printed with an aqueous ink containing
   3.8% by weight of the dye of formula (IX) 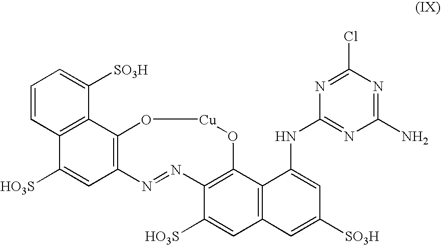
   15% by weight of 1,2-propylene glycol and
   81.2% by weight of water
      using a continuous flow inkjet head. The print is completely dried and fixed in saturated steam at 102° C. for 4 minutes, rinsed cold, washed off at the boil, rinsed once more and dried. A navy blue print having good fastnesses and moderate light fastness is obtained.

### Application Example 11

a) Mercerized cotton satin is padded with a liquor containing 30 g/l of sodium carbonate to a wet pick-up of 70% and dried.
b) The cotton satin pretreated as per step a) is printed with an aqueous ink containing 2.4% by weight of the dye composition (X) which is a mixture comprising the following three dyestuffs
   61 parts of the dye (Xa) 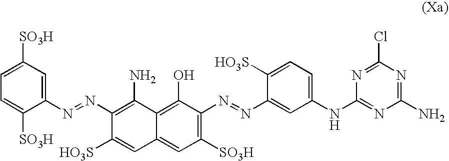
   28 parts of the dyes (Xb) 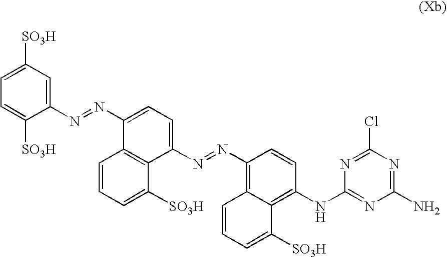
   and
   9 parts of the dye (Xc) 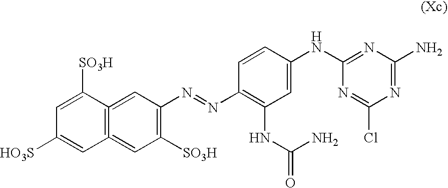
   0.3% of hydroxyethylcellulose,
   0.5% by weight of borax and
   86.8% by weight of water
      using a continuous flow inkjet head. The print is completely dried and fixed in saturated steam at 102° C. for 4 minutes, rinsed cold, washed off at the boil, rinsed once more and dried. A black print having good fastnesses and good lightfastness is obtained.

### Application Example 12

a) Mercerized cotton satin is padded with a liquor containing 30 g/l of sodium carbonate to a wet pick-up of 70% and dried.
b) The cotton satin pretreated as per step a) is printed with an aqueous ink containing
   4.4% by weight of the dye of formula (XI) 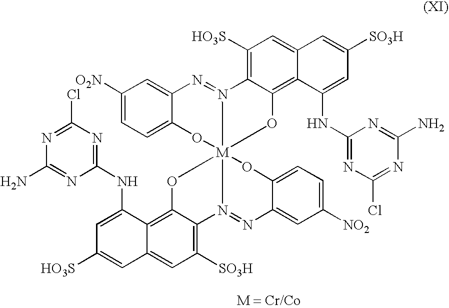
   0.3% of hydroxyethylcellulose,
   0.5% by weight of borax and
   84.8% by weight of water
      using a continuous flow inkjet head. The print is completely dried and fixed in saturated steam at 102° C. for 4 minutes, rinsed cold, washed off at the boil, rinsed once more and dried. A black print having good fastnesses and good lightfastness is obtained.

### Application Example 13

a) Mercerized cotton satin is padded with a liquor containing 30 g/l of sodium carbonate to a wet pick-up of 70% and dried.
b) The cotton satin pretreated as per step a) is printed with an aqueous ink mixture containing 50 parts of ink XI from application example 12 (containing dye of formula XI) and 50 parts of ink I from application example 1 (containing dye of formula I). The print is completely dried and fixed in saturated steam at 102° C. for 4 minutes, rinsed cold, washed off at the boil, rinsed once more and dried.

The oliv-green print shows good fastnesses and good lightfastness properties and no catalytic fading.

### Application Example 14

a) Mercerized cotton satin is padded with a liquor containing 30 g/l of sodium carbonate to a wet pick-up of 70% and dried.
b) The cotton satin pretreated as per step a) is printed with an aqueous ink mixture containing 50 parts of ink XI from application example 12 (containing dye of formula XI) and 50 parts of ink II from application example 2 (containing dye of formula II). The print is completely dried and fixed in saturated steam at 102° C. for 4 minutes, rinsed cold, washed off at the boil, rinsed once more and dried.

The oliv-green print shows good fastnesses and good lightfastness properties and no catalytic fading.

### Application Example 15

a) Mercerized cotton satin is padded with a liquor containing 30 g/l of sodium carbonate to a wet pick-up of 70% and dried.
b) The cotton satin pretreated as per step a) is printed with an aqueous ink mixture containing 50 parts of ink XI from application example 12 (containing dye of formula XI) and 50 parts of ink IIIa from application example 3 (containing dye of formula IIIa). The print is completely dried and fixed in saturated steam at 102° C. for 4 minutes, rinsed cold, washed off at the boil, rinsed once more and dried.

The dark rose-coloured print shows good fastnesses and good lightfastness properties and no catalytic fading.

### Application Example 16

a) Mercerized cotton satin is padded with a liquor containing 30 g/l of sodium carbonate to a wet pick-up of 70% and dried.
   b) The cotton satin pretreated as per step a) is printed with an aqueous ink mixture containing 50 parts of ink XI from application example 12 (containing dye of formula XI) and 50 parts of ink IIIb from application example 4 (containing dye of formula III b). The print is completely dried and fixed in saturated steam at 102° C. for 4 minutes, rinsed cold, washed off at the boil, rinsed once more and dried.

The dark rose-coloured print shows good fastnesses and good lightfastness properties and no catalytic fading.

### Application Example 17

a) Mercerized cotton satin is padded with a liquor containing 30 g/l of sodium carbonate to a wet pick-up of 70% and dried.
b) The cotton satin pretreated as per step a) is printed with an aqueous ink mixture containing 50 parts of ink XI from application example 12 (dye of formula XI) and 50 parts of ink IV from application example 5 (containig dye of formula IV).

The print is completely dried and fixed in saturated steam at 102° C. for 4 minutes, rinsed cold, washed off at the boil, rinsed once more and dried.

The ruby-red print shows good fastnesses and good lightfastness properties and no catalytic fading.

### Application Example 18

a) Mercerized cotton satin is padded with a liquor containing 30 g/l of sodium carbonate to a wet pick-up of 70% and dried.
b) The cotton satin pretreated as per step a) is printed with an aqueous ink mixture containing 50 parts of ink XI from application example 12 (containing dye of formula XI) and 50 parts of ink V from application example 6 (containing dye of formula V). The print is completely dried and fixed in saturated steam at 102° C. for 4 minutes, rinsed cold, washed off at the boil, rinsed once more and dried.

The grey-violet print shows good fastnesses and good lightfastness properties and no catalytic fading.

### Application Example 19

a) Mercerized cotton satin is padded with a liquor containing 30 g/l of sodium carbonate to a wet pick-up of 70% and dried.
b) The cotton satin pretreated as per step a) is printed with an aqueous ink mixture containing 50 parts of ink XI from application example 12 (containing dye of formula XI) and 50 parts of ink VI from application example 7 (containing dye of formula VI). The print is completely dried and fixed in saturated steam at 102° C. for 4 minutes, rinsed cold, washed off at the boil, rinsed once more and dried.

The aqua-coloured print shows good fastnesses and good lightfastness properties and no catalytic fading.

### Application Example 20

a) Mercerized cotton satin is padded with a liquor containing 30 g/l of sodium carbonate to a wet pick-up of 70% and dried.
b) The cotton satin pretreated as per step a) is printed with an aqueous ink mixture containing 50 parts of ink XI from application example 12 (containing dye of formula XI) and 50 parts of ink VIII from application example 9 (containing dye of formula VIII). The print is completely dried and fixed in saturated steam at 102° C. for 4 minutes, rinsed cold, washed off at the boil, rinsed once more and dried.

The dark blue print shows good fastnesses and good lightfastness properties and no catalytic fading.

### Application Example 21

a) Mercerized cotton satin is padded with a liquor containing 30 g/l of sodium carbonate to a wet pick-up of 70% and dried.
b) The cotton satin pretreated as per step a) is printed with an aqueous ink mixture containing 50 parts of ink XI from application example 12 (containing dye of formula XI) and 50 parts of ink X from application example 12 (containing dye of formula X). The print is completely dried and fixed in saturated steam at 102° C. for 4 minutes, rinsed cold, washed off at the boil, rinsed once more and dried.

The anthracite print shows good fastnesses and good lightfastness properties and no catalytic fading.

### Application Example 22

a) Mercerized cotton satin is padded with a liquor containing 30 g/l of sodium carbonate to a wet pick-up of 70% and dried.
b) The cotton satin pretreated as per step a) is printed with an aqueous ink mixture containing 50 parts of ink VIII from application example 9 (containing dye of formula VIII) and 50 parts of ink I from application example 1 (containing dye of formula I). The print is completely dried and fixed in saturated steam at 102° C. for 4 minutes, rinsed cold, washed off at the boil, rinsed once more and dried.

The greenish print shows good fastnesses and good lightfastness properties and no catalytic fading.

### Application Example 23

a) Mercerized cotton satin is padded with a liquor containing 30 g/l of sodium carbonate to a wet pick-up of 70% and dried.
b) The cotton satin pretreated as per step a) is printed with an aqueous ink mixture containing 50 parts of ink VIII from application example 9 (containing dye of formula VIII) and 50 parts of ink II from application example 2 (containing dye of formula II). The print is completely dried and fixed in saturated steam at 102° C. for 4 minutes, rinsed cold, washed off at the boil, rinsed once more and dried.

The blue-greenish print shows good fastnesses and good lightfastness properties and no catalytic fading.

### Application Example 24

a) Mercerized cotton satin is padded with a liquor containing 30 g/l of sodium carbonate to a wet pick-up of 70% and dried.
b) The cotton satin pretreated as per step a) is printed with an aqueous ink mixture containing 50 parts of ink VIII from application example 9 (containing dye of formula VIII) and 50 parts of ink II from application example 3 (containing dye of formula IIIa). The print is completely dried and fixed in saturated steam at 102° C. for 4 minutes, rinsed cold, washed off at the boil, rinsed once more and dried.

The red-violet print shows good fastnesses and good lightfastness properties and no catalytic fading.

### Application Example 25

a) Mercerized cotton satin is padded with a liquor containing 30 g/l of sodium carbonate to a wet pick-up of 70% and dried.
b) The cotton satin pretreated as per step a) is printed with an aqueous ink mixture containing 50 parts of ink VIII from application example 9 (containing dye of formula VIII) and 50 parts of ink IIIb from application example 4 (containing dye of formula IIIb). The print is completely dried and fixed in saturated steam at 102° C. for 4 minutes, rinsed cold, washed off at the boil, rinsed once more and dried.

The red-violet print shows good fastnesses and good lightfastness properties and no catalytic fading.

### Application Example 26

a) Mercerized cotton satin is padded with a liquor containing 30 g/l of sodium carbonate to a wet pick-up of 70% and dried.
b) The cotton satin pretreated as per step a) is printed with an aqueous ink mixture containing 50 parts of ink VIII from application example 9 (containing dye of formula VIII) and 50 parts of ink IV from application example 5 (containing dye of formula IV). The print is completely dried and fixed in saturated steam at 102° C. for 4 minutes, rinsed cold, washed off at the boil, rinsed once more and dried.

The violet print shows good fastnesses and good lightfastness properties and no catalytic fading.

### Application Example 27

a) Mercerized cotton satin is padded with a liquor containing 30 g/l of sodium carbonate to a wet pick-up of 70% and dried.
b) The cotton satin pretreated as per step a) is printed with an aqueous ink mixture containing 50 parts of ink VIII from application example 9 (containing dye of formula VIII) and 50 parts of ink V from application example 6 (containing dye of formula V). The print is completely dried and fixed in saturated steam at 102° C. for 4 minutes, rinsed cold, washed off at the boil, rinsed once more and dried.

The blue-violet print shows good fastnesses and good lightfastness properties and no catalytic fading.

### Application Example 28

a) Mercerized cotton satin is padded with a liquor containing 30 g/l of sodium carbonate to a wet pick-up of 70% and dried.
   b) The cotton satin pretreated as per step a) is printed with an aqueous ink mixture containing 50 parts of ink VIII from application example 9 (containing dye of formula VIII) and 50 parts of ink VII from application example 8 (containing dye of formula VII). The print is completely dried and fixed in saturated steam at 102° C. for 4 minutes, rinsed cold, washed off at the boil, rinsed once more and dried.

The royal-blue print shows good fastnesses and good lightfastness properties and no catalytic fading.

### Application Example 29

a) Mercerized cotton satin is padded with a liquor containing 30 g/l of sodium carbonate to a wet pick-up of 70% and dried.
b) The cotton satin pretreated as per step a) is printed with an aqueous ink mixture containing 50 parts of ink VIII from application example 9 (containing dye of formula VIII) and 50 parts of ink X from application example II (containing dye of formula X). The print is completely dried and fixed in saturated steam at 102° C. for 4 minutes, rinsed cold, washed off at the boil, rinsed once more and dried.

The grey-blue print shows good fastnesses and good lightfastness properties and no catalytic fading.

### Application Example 30

a) Mercerized cotton satin is padded with a liquor containing 30 g/l of sodium carbonate to a wet pick-up of 70% and dried.
b) The cotton satin pretreated as per step a) is printed with an aqueous ink mixture containing 50 parts of ink VI from application example 7 (containing dye of formula VI) and 50 parts of ink II from application example 2 (containing dye of formula II). The print is completely dried and fixed in saturated steam at 102° C. for 4 minutes, rinsed cold, washed off at the boil, rinsed once more and dried.

The green print shows good fastnesses and good lightfastness properties and no catalytic fading.

### Application Example 31

a) Mercerized cotton satin is padded with a liquor containing 30 g/l of sodium carbonate to a wet pick-up of 70% and dried.)
b) The cotton satin pretreated as per step a) is printed with an aqueous ink mixture containing 50 parts of ink V from application example 6 (containing dye of formula V) and 50 parts of ink VII from application example 8 (containing dye of formula VII). The print is completely dried and fixed in saturated steam at 102° C. for 4 minutes, rinsed cold, washed off at the boil, rinsed once more and dried.

The brilliant-violet print shows good fastnesses and good lightfastness properties and no catalytic fading.

1. A printing process showing no catalytic fading when a dyestuff or a dyestuff mixture of a first step and a second step are brought in contact on a substrate and having a common overlapping area on said substrate comprising in said first step applying at least one dyestuff or a dyestuff mixture selected from the group consisting of dyes of the formula (I), (II), (IIIa), (IIIb), (IV), (V), (VI), (VII), (VIII), (IX), (X) and (XI) 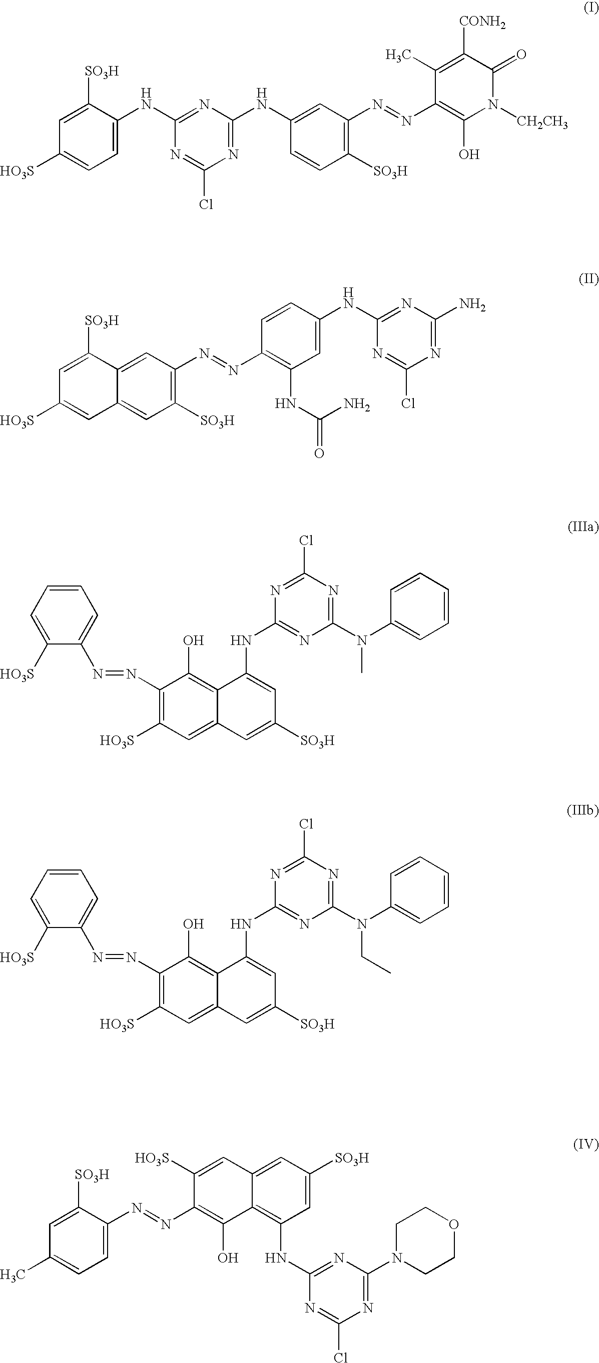 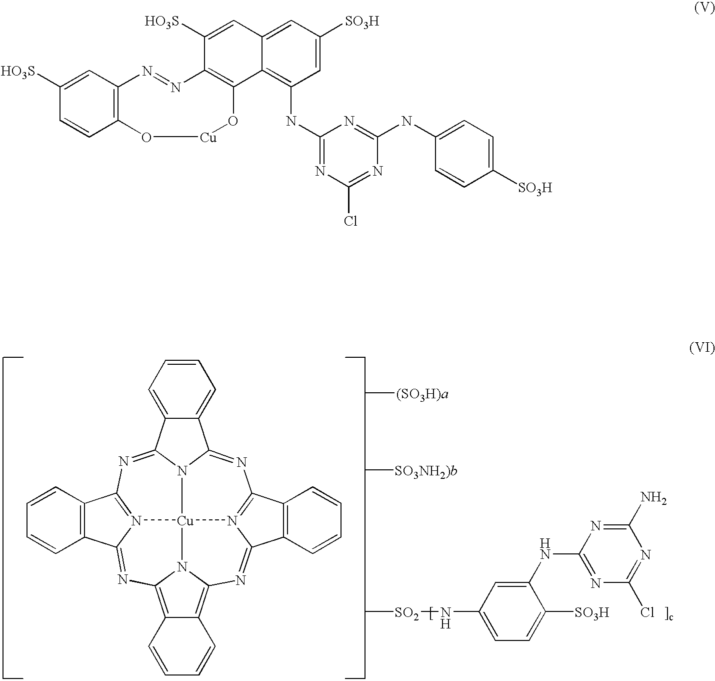
with a being from 4 to 0 and b being from 0 to 4 with the proviso that the sum of a+b does not exceed 4 and c from 1 to 2, 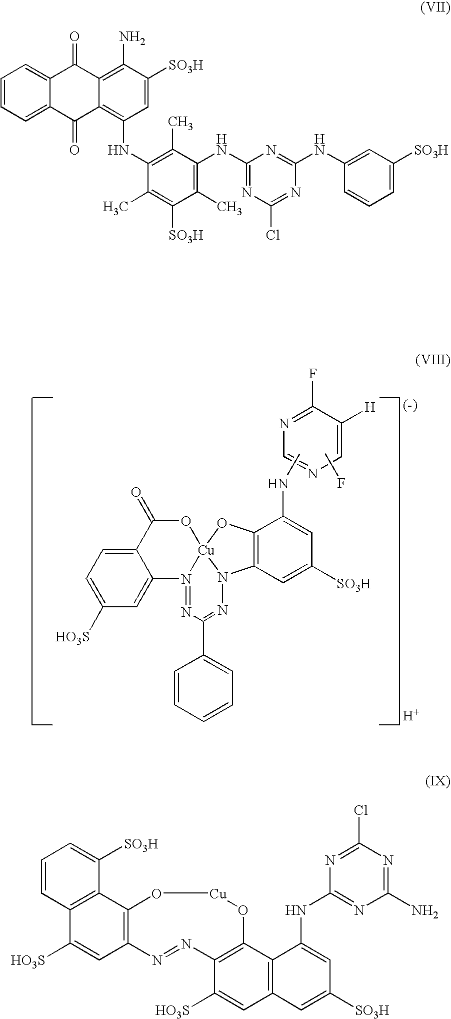
wherein dye composition (X) is a mixture comprising 61 parts of the dye (Xa), 28 parts of the dye (Xb) and 9 parts of the dye (Xc) 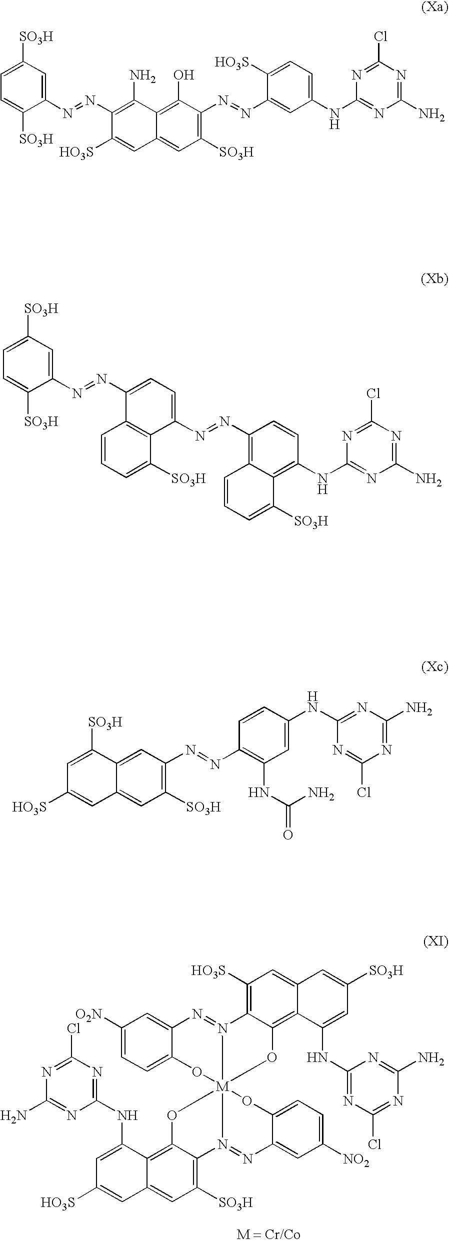
and in said second step applying at least one dyestuff or a dyestuff mixture selected from the group consisting of the dyes of the formula (I) or (II) or (IIIa) or (IIIb) or (IV) or (V) or (VI) or (VII) or (VIII) or (IX) or (X) or (XI) with the proviso that the dyestuff or mixture of dyestuffs in the second step is not the same dyestuff or mixture of dyestuff as selected in the first step.

2. A printing process showing no catalytic fading according to claim 1 further comprising a third step of applying at least one dyestuff or a dyestuff mixture selected from at dye of the formula (I) or (II) or (IIIa) or (IIIb) or (IV) or (V) or (VI) or (VII) or (VIII) or (IX) or (X) or (XI) with the proviso that the dyestuff or mixture of dyestuffs in the third step is not the same dyestuff or mixture of dyestuff as selected in the first step or in the second step.

3. A printing process showing no catalytic fading according to claim 1 wherein the printing process is a polychromatic printing process for printing recording materials.

4. A printing process showing no catalytic fading according to claim 1 wherein a hydroxy group containing substrate is printed.

5. A printing process showing no catalytic fading according to claim 1 wherein the printing process is an ink jet printing process

6. A printing process showing no catalytic fading according to claim 1 wherein the total content of salts is less than 0.5% by weight, based on the total weight of the dyes.

7. A method for a printing recording material by the inkjet printing process, comprising the step of printing the recording material with a composition including:
1) at least one dye of the formula (I) or (V) or (VI) or (VIII), 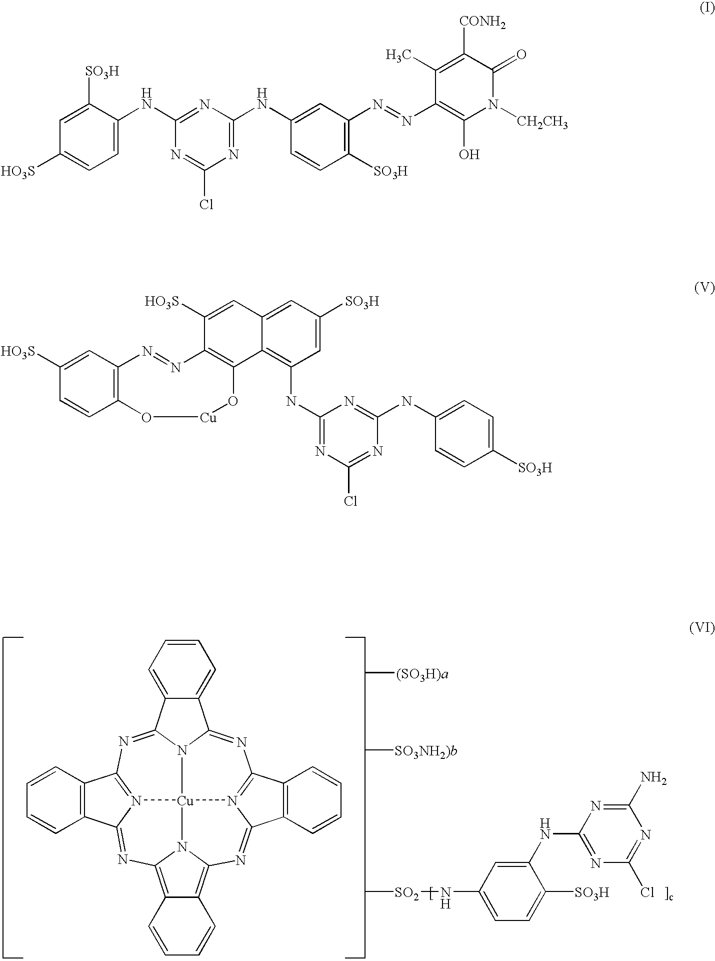
with a being from 4 to 0 and b being from 0 to 4 with the proviso that the sum of a+b does not exceed 4 and c is from 1 to 2 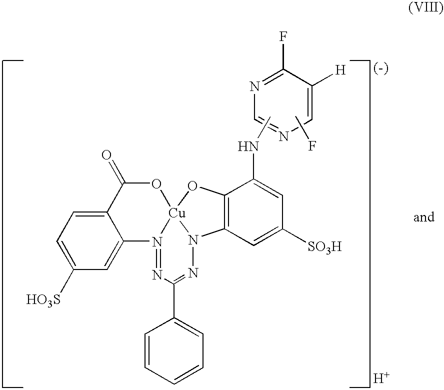
2) water or a medium including a mixture of water and an organic solvent, an anhydrous organic solvent or a solid having a low melting point.

8. The method according to claim 7 wherein the composition has a total content of salts less than 0.5% by weight, based on the total weight of the dyes.

9. The method according to claim 7 wherein the recording material is selected from the group consisting of paper and papery substrates, textile fibre materials and plastic films and plastic transparencies comprising hydroxy groups.

10. A recording material made in accordance with the method of claim 7.

11. An article printed in accordance with the process according to claim 1.

12. A composition for printing recording material by the inkjet printing process, comprising:
1) at least one dye of the formula (I) or (V) or VI) or (VIII), 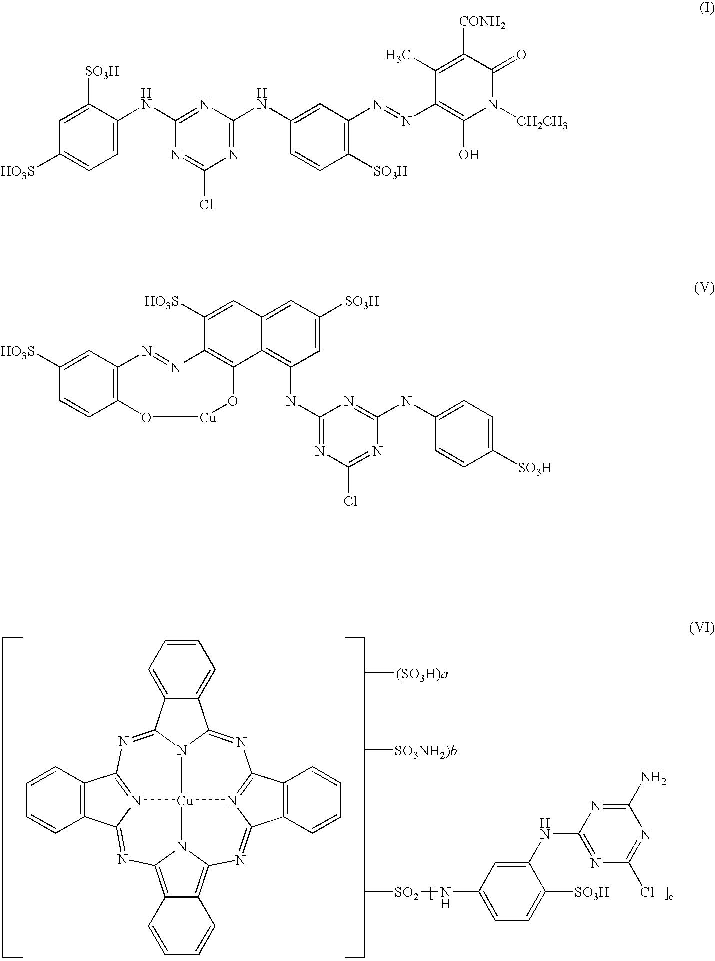
with a being from 4 to 0 and b being from 0 to 4 with the proviso that the sum of a+b does not exceed 4 and c is from 1 to 2 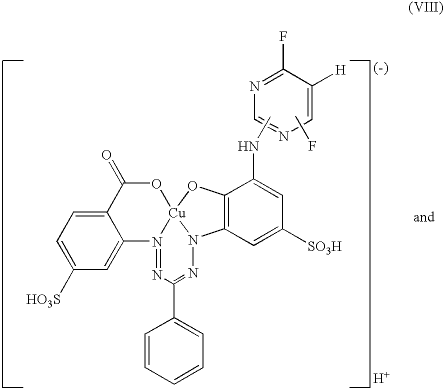
2) water or a medium including a mixture of water and an organic solvent, an anhydrous organic solvent or a solid having a low melting point.
